(19) United States
(12) Patent Application Publication
(10) Pub. No.: US 2026/0308889 A1
(43) Pub. Date: Oct. 8, 2026

(54) SYSTEM AND METHOD FOR MACHINE MONITORING

(71) Applicant: Caterpillar Inc., Peoria, IL (US)

(72) Inventors: Yanchai Zhang, Dunlap, IL (US); Chunhui Pan, Edwards, IL (US); Daojie Zhang, Northbrook, IL (US); Xuefei Hu, Dunlap, IL (US)

(73) Assignee: Caterpillar Inc., Peoria, IL (US)

(21) Appl. No.: 19/098,490

(22) Filed: Apr. 2, 2025

(51) Int. Cl. E02F 9/26; G07C 5/00; G07C 5/08; G09B 9/05

(52) U.S. Cl. CPC E02F 9/267; G07C 5/006; G07C 5/008; G07C 5/0808; G07C 5/0825; G09B 9/05

(57) ABSTRACT

Generation of a reduced order model (ROM)-based digital twin and use of the digital twin during real time operation at an edge device to provide monitoring and coaching of operation of a work machine. Leveraging digital twin generation, artificial intelligence and machine learning analytics to provide real time coaching to prevent or encourage operators to avoid operations that may cause undue stress or wear on the work machine. A reduced order model (ROM) may be generated for each component of a work machine and/or the work machine as a whole. After generation of an initial ROM model and/or after enhancement or tuning of the initial ROM model with real-time information, a digital twin of the work machine and its components may be generated and used for monitoring machine health and coaching operators during use.

### TECHNICAL FIELD

The present disclosure generally relates to equipment analysis, maintenance monitoring, operator training, and fleet management. More particularly, the present disclosure relates to generation of digital twins of equipment components and use of the digital twins for monitoring and coaching use of equipment for equipment analysis, maintenance monitoring, operator training, and fleet management.

### BACKGROUND

Modern machines such as vehicles of various types include a variety of machine systems, subsystems, and individual components, for example, engines, motors, transmission systems, braking systems, steering systems, hydraulic systems, pneumatic systems, and the like. Systems, subsystems and/or components are often embedded inside a given equipment part or component making monitoring for damage and/or maintenance difficult and time-consuming. For example, components of a brake assembly of an earth moving machine, such as a bulldozer, front-end loader, skid steer, or a road or rail vehicle such as an automobile, trailer tractor, locomotive, and the like are typically located inside an enclosed brake assembly or behind wheel assemblies, or track assemblies. For another example, components of a machine engine, motor, or transmission system are typically enclosed inside an engine/motor assembly or compartment.

Unfortunately, for purposes of condition monitoring of equipment such as hydraulic mining shovels (HMS) or other such equipment, failure of components leads to significant downtime that is costly for an operation.

In addition to system analysis and maintenance, operator training is important because a given operator may be utilizing a piece of equipment in a manner (e.g., speed, acceleration, braking, etc.) that leads to system, subsystem and/or component damage or failure. The above-mentioned difficulties associated with system analysis and maintenance similarly make it difficult to train operators because often a system, subsystem or component failure may occur without information to alert an operator as to causes or potential causes of the failure related to operator performance.

An example system and method for generating a digital twin of a vehicle (e.g., a recreational vehicle) is described in U.S. patent application 20230074139A1 to Ghosh et al., filed Sep. 3, 2021, by applicant International Business Machines Corporation titled “Proactive Maintenance for Smart Vehicle” (hereafter “the '139 document”). In particular, the '139 document describes using an input data set associated with a plurality of vehicle components and one or more vehicle performance factors to produce a digital twin of the vehicle.

Although the '139 document describes generating a digital twin of a recreational vehicle and using the digital twin to inspect or predict the impact of operating conditions on the vehicle, the methods and systems described in the '139 document are computationally expensive and require significant data and computing resources. Moreover, the methods and systems of the '139 document do not provide for adequate interactive use of digital twins associated with a vehicle, machine, or other type of equipment and in particular for on-edge modeling of the equipment and understanding of the stresses on the machine in addition to providing coaching to operators of the equipment.

Examples of the present disclosure are directed to overcoming the deficiencies described above.

### SUMMARY OF THE INVENTION

Systems and methods are provided for reduced order model (ROM)-based generation of digital twins and augmented reality renderings for components of a work machine. A method includes receiving system data from a work machine and passing the system data to a reduced order model system. At the reduced order model system, a reduced order model is generated for the work machine. The reduced order model for the work machine is passed to a digital twin model system. At the digital twin model system, a digital twin is generated for the work machine. According to examples, the digital twin system may be used for monitoring use of the equipment including stress and strain on the equipment during operation as well as to provide coaching to guidance to an operator on techniques for using the equipment without undue wear and tear on the equipment that may increase machine downtime and maintenance. According to examples of the present disclosure, a health indicator may be applied to a feature of the system and may be used for monitoring and real-time coaching for the equipment.

If system data or operating conditions data for the work machine changes, the ROM model for the work machine may be updated. In response, the digital twin may be updated. Operating conditions data for the work machine also may be passed to a machine learning model for training the machine learning model. Information (learnings) from the machine learning model may be used to update or tune the ROM model for the work machine.

According to another example, a system is provided. The system may include a work machine having an electronic control module configured to pass system data and real time operating conditions data for the work machine to a reduced order model system. The reduced order model system is configured to generate a reduced order model for the work machine based at least in part on the system data and real time operating conditions data for the work machine. The reduced order model system is further configured to pass the reduced order model for the work machine to a digital twin model system. The digital twin model system is configured to generate a digital twin for the work machine based at least in part on the system data and real time operating conditions data for the work machine. An on-edge computing device may use the digital twin for real-time coaching and monitoring of the equipment for identifying actions and coaching to increase the working life and decrease the downtime for the equipment.

According to another example, a method is provided and includes transmitting system data and operating conditions data from a work machine to a cloud-based analysis system or an on-edge computing system. At the analysis system, the system data and the operating conditions data are passed to a reduced order model system. At the reduced order model system, a reduced order model is generated for the work machine. At the analysis system, the reduced order model for the work machine is passed to a digital twin model system. At the digital twin model system, a digital twin for the work machine is generated. At the analysis system, the digital twin for the work machine is passed to a monitoring and coaching system. At the monitoring and coaching system, the use of the equipment is monitored and operator coaching is provided in real-time from the digital twin.

The monitoring data of the work machine and real time insights may be transmitted to a remote support and collaboration system for determining maintenance requirements for the work machine based at least in part on the real-time monitoring using the ROM and digital twin. Additionally, data may be received from across a fleet of work machines to monitor health and usage of the work machines to identify and coach against behavior that may increase downtime for the equipment or lead to a shortened work life.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an environment for implementing a reduced order model (ROM)-based digital twin and coaching system, according to examples of the present disclosure.

FIG. 2 illustrates a system for generating a ROM-based digital twin of an equipment system, subsystem, or component and for utilizing the digital twin for coaching and monitoring the equipment system, according to examples of the present disclosure.

FIG. 3 illustrates an architecture for utilization of a ROM-based digital twin, according to examples of the present disclosure.

FIG. 4 illustrates example user interfaces for implementing a ROM-based digital twin of an equipment system for operator coaching, according to examples of the present disclosure.

FIG. 5 illustrates an example user interface for monitoring equipment using a ROM-based digital twin, according to examples of the present disclosure.

FIG. 6 illustrates an example user interface for monitoring equipment using a ROM-based digital twin, according to examples of the present disclosure.

FIG. 7 illustrates an example user interface for monitoring equipment using a ROM-based digital twin, according to examples of the present disclosure.

FIG. 8 illustrates a flow diagram of an example method for generation and utilization of a ROM-based digital twin of an equipment system, according to examples of the present disclosure.

FIG. 9 illustrates a computer architecture diagram showing illustrative hardware architecture for implementing aspects of various technologies of the present disclosure.

### DETAILED DESCRIPTION

Wherever possible, the same reference numbers will be used throughout the figures to refer to the same or like parts. In the figures, the left-most digit(s) of a reference number identifies the figure in which the reference number first appears.

Accordingly, the systems and methods described herein provide monitoring to enable early failure detections or even preventions. The description provided herein enables early detection of component wear and/or early prediction of wear or failure of components. Additionally, the description provides for coaching operators of equipment to prevent excessive wear or damage to equipment components during operation. Accordingly, the description provided herein enables real-time operation coaching model that includes structural health monitoring.

In an illustrative example, the present disclosure is related to the product condition monitoring of hydraulic mining shovels (HMS). Conventional HMS operator coaching models have focused on data-driven solutions for cycle segmentation and productivity. More particularly, the present disclosure pertains to a closed-loop hydraulic mining shovel (HMS) operator coaching with structural digital twin models on-edge. The HMS operator coaching system integrates a physical-based Digital Twin and Reduced Order Models (ROM) technology to create a solution for component and system condition monitoring. ROM reduces model size and runtime while maintaining accurate predictions, making it useful for digital twins-based monitoring. The system uses virtual sensors and cameras, providing more insights than limited physical sensors which are also expensive and require maintenance. An electronic control module (ECM) of the HMS may be used to calculate component stress levels and identify operator behavior that may result in excessive wear or damage to the HMS under various operating conditions. Real-time feedback for operator instruction is sent to on-site operation, allowing operators to adjust their actions before mechanical failure occurs.

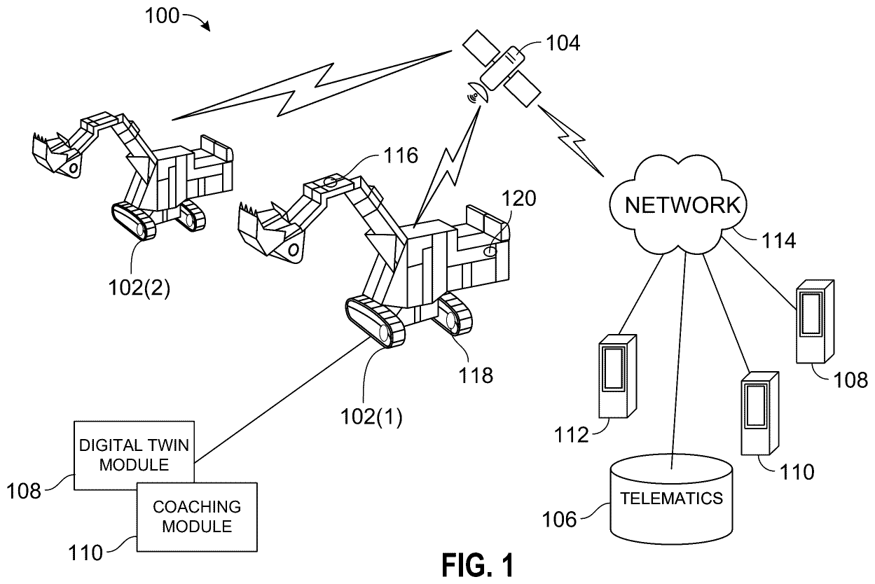

FIG. 1 illustrates an environment 100 for implementing a reduced order model (ROM)-based digital twin and coaching system, according to examples of the present disclosure. The environment 100 may include multiple machines, such as HMS 102(1) and 102(2), a satellite 104, telematics database 106, a physics-based digital twin module 108, a coaching module 110, a ROM system 112, and a network 114. The network 114 may connect the HMS 102(1) and 102(2) to the components, which also may be hosted on-board the HMS 102(1) and 102(2), for example on an ECM of the HMS 102(1) and 102(2). The telematics database 106 may receive data from the HMS 102(1) and 102(2) via the satellite 104. The telematics data may include sensor data such as a pressure sensor 116, vibration sensor 118, and a temperature sensor 120, among other sensor types. In embodiments, the sensor data may be communicated or sent to the ECM of the HMS 102(1) and/or 102(2) for calculations based on the sensor and operating data.

The digital twin module 108 and the coaching module 110 may be used to improve monitoring and reduce downtime for work machines, as described herein, for example by coaching operators to avoid actions or behavior that causes undue stress or wear on the equipment of the HMS 102(1) and 102(2). The digital twin module 108 may use physics-based simulations of the HMS 102(1) and 102(2) to generate a ROM of the work machines. Physics-based machine and system simulations created for product development can be leveraged to improve condition monitoring applications. A physics-based simulation model that has been calibrated to closely match the normal behavior of the physical system is defined as a digital twin of that physical system. The calibrated digital twin for normal behavior can be converted to a lower fidelity model e.g., reduced-order model (ROM) based on deep learning to improve efficiency and lower cost of the baseline comparisons. Telematics data from components of the work machine is used as inputs for the digital twin-based ROM. If the difference in outputs between the ROM and physical system are within a defined threshold (within e.g., 10 percent of the ROM), monitoring of the system continues. Otherwise, if the difference in outputs exceed (either below or above) the defined threshold, additional simulations may be performed using physics-based digital twins-based ROMs.

A coaching module 110 integrates a physical-based digital twin and ROM technology to reduce model size and runtime while maintaining accurate predictions. The technology enables digital twins-based component and system condition monitoring, reducing the need for numerous physical sensors. The system uses scalable virtual sensors and cameras, providing more insights than limited physical sensors. The virtual sensor output calculates component stress levels and identifies incorrect operator behavior under various operating conditions. Real-time feedback for operator instruction is then sent to on-site operation including on-board the HMS 102(1) and 102(2) and/or to an on-site operator, allowing operators to adjust their actions before mechanical failure occurs.

ROM can reduce the model size and runtime significantly, while maintaining accurate predictions. Because of these benefits, ROM is useful and an enabler of digital twins-based component and system condition monitoring. These digital twins can leverage the “virtual sensor” techniques, decreasing the need for numerous physical sensors which are costly, difficult to install, and prone to environmental damage. Additionally, the reduced model size and reduce computing demands enable calculations at or near real-time using the limited computing systems that may be positioned on-board the HMS 102(1) and 102(2) for example in an ECM.

The coaching module 110 may integrate the digital twin from the digital twin module 108. The digital twin may be developed using only existing sensors and electronics of the HMS 102(1) and 102(2) rather than additional retrofitted sensors. Accordingly, the use of virtual sensors and cameras used herein are scalable and can be used to provide more insights and information related to the stresses in the system than limited physical sensors. The virtual sensor output from the ROM model on ECM calculates the stress level of components and identifies incorrect operator behavior under various operating conditions. In examples, the coaching module 110 may be configured to detect behavior such as jump steering, boom jacking, cylinder end stroke, wall scraping, swing impact, sweeping, hammering, levering, tipping, and other such behaviors that may result in damage or wear to the HMS 102(1) and 102(2). The coaching module 110 may be used to provide real-time feedback for operator instruction, allowing the operator to adjust their actions accordingly before mechanical failure occurs.

The ROM may be generated by the digital twin module 108 and/or other component for each component or selected components of the HMS 102(1) and 102(2). The ROM model may be initially generated based on specifications of the HMS 102(1) and 102(2) including detailed information on each component of the HMS. The initially generated ROM model may be enhanced by feeding the ROM model real-time component data such as received from internal sensors associated with work machine components and by feeding the ROM model with real-time operating conditions such as work machine speed, acceleration, deceleration, braking, work machine loading data, work machine operating terrain, work machine material handling information, as well as environmental conditions such as temperature, wind velocity, moisture presence, and the like. Information used for enhancing or tuning an initially generated ROM model may be fed directly to the ROM model or may be processed by a machine learning and artificial intelligence system that, in turn, may feed information to enhance the ROM model to a ROM model system.

According to examples, after generation of an initial ROM model and/or after enhancement or tuning of the initial ROM model with real-time information, a digital twin of the work machine and its components may be generated. According to examples, operators of the HMS 102(1), operator training personnel, maintenance personnel, and/or fleet management personnel may utilize the coaching module for determining behaviors and actions that may reduce the wear on the HMS and/or for predicting future problems with components of the HMS 102(1) and 102(2), for training operators, for assisting maintenance personnel, and for assisting in management of work machine fleets.

As illustrated in FIG. 1, the HMS 102(1) and 102(2) is provided as an example of a work machine with which various types of work, for example, earth moving, material moving, and the like may be performed. The work machine illustrates a typical HMS though other work machines such as a front-end loader with which material such as dirt, rock, concrete, wood, steel, and the like may be moved from one location to another or may be loaded onto or unloaded from a transport, such as a truck or trailer. The work machine, illustrated in FIG. 1, is for purposes of example only and is not limiting of other types of work machines that may be utilized according to examples of the present disclosure. For example, the work machine may include a front-end loader, bulldozer, skid steer, tractor, large-scale earth moving machine, and the like. In addition, as will be appreciated, examples of the present disclosure may be utilized with other types of vehicles, including but not limited to aircraft, automobiles, trucks, trailers, as well as any type of non-vehicle machine, and the like.

Referring still to FIG. 1, the HMS 102(1) includes a cab in which an operator controls the HMS 102(1). The engine compartment includes space for a combustion engine, hybrid combustion/electric engine/motor combination, or an electric motor system for a fully electric work machine. An under-cab section is provided in which various systems such as transmissions, cabin cooling systems, and the like may be maintained. As will be described below, the under-cab section also may include various control systems available for operation of the work machine. Drive assemblies are provided for moving the work machine.

The HMS 102(1) further includes components required for movement and use of a work tool attached to the HMS 102(1). The components may articulate move an attached work tool as required for picking up, dropping and/or pushing material. For example, the work tool illustrated in FIG. 1 is a bucket with which material may be pushed, scooped, lifted, dumped, and the like. Other types of work tools may include blades for pushing material, forks for lifting material such as pallets, and the like. Different types of work tools that may be utilized with the HMS are well known to those skilled in the art. As should be appreciated, the configuration of components of the HMS 102(1), illustrated in FIG. 1, is for purposes of illustration an example only.

Referring still to FIG. 1, according to examples of the present disclosure, a work machine operator, training person, maintenance person, fleet management person, and the like may interact with the HMS 102(1) for reviewing components of the HMS 102(1) for which a ROM model, digital twin, and coaching module is generated. According to examples, the coaching module 110 may be provided according to a number of methods. For example, a computing device, such as a phone, tablet, laptop computer, desktop computer, or the like may be used to provide an interface for viewing, interacting with, and/or following the instructions of the coaching module 110.

The system shown in FIG. 1 enables the HMS 102(1) and/or HMS 102(2) to integrate a physical-based Digital Twin and ROM to create a solution for component and system condition monitoring and real-time coaching of operation of the machine. The ROM reduces model size and runtime while maintaining accurate predictions, making it useful for digital twins-based monitoring. The system uses virtual sensors and cameras, providing more insights than limited physical sensors which are also expensive and require maintenance. An electronic control module (ECM) of the HMS 102(1) or 102(2) may be used to calculate component stress levels and identify operator behavior that may result in excessive wear or damage to the HMS under various operating conditions. Real-time feedback for operator instruction is sent to on-site operation, allowing operators to adjust their actions before mechanical failure occurs. Additionally, the system 100 may be used to provide fleet monitoring from a back-office or central controller to enable visibility across a fleet for component and machine monitoring.

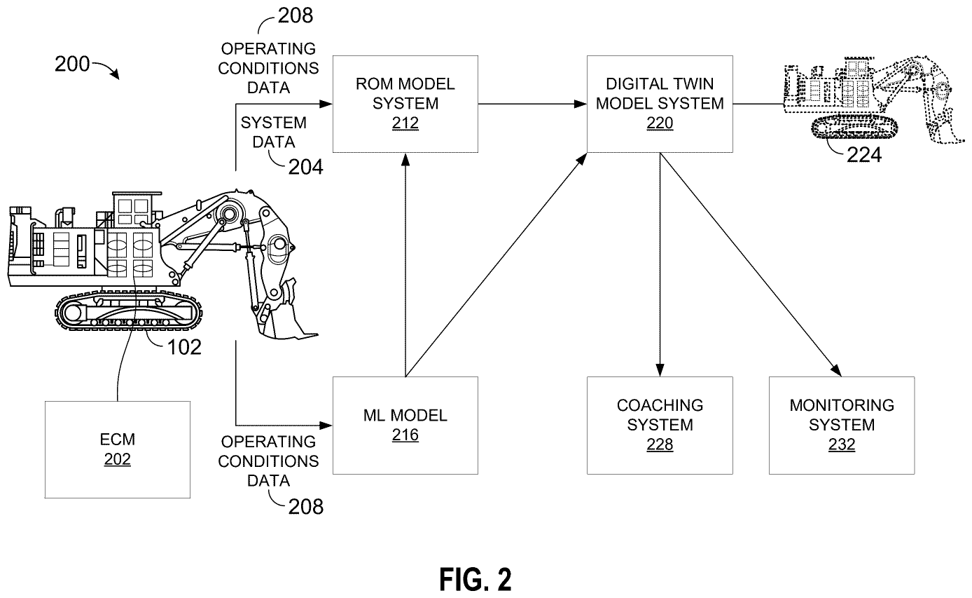

FIG. 2 illustrates a system 200 for generating a ROM-based digital twin of an equipment system, subsystem, or component and for utilizing a digital twin as part of a coaching and monitoring system for a work machine, according to examples of the present disclosure. According to examples, data of various types is passed to a reduced order model (ROM) system 212 where a ROM model is generated for components of the work machine 102. As described herein, the ROM model generated by the ROM system 212 may be enhanced or tuned by information processed by a machine learning model 216. The ROM model generated and tuned (as desired) may then be passed to a digital twin model system 220 where a digital twin 224 of the work machine 102 may be generated. In addition, the digital twin 224 may be utilized by a coaching system 228 and/or monitoring system 232 for providing coaching on operating the work machine 102 without causing undue stress and reducing the working life of the work machine 102 as well as to monitor the work machine 102 or a fleet of work machines to provide insights into operations, maintenance, and use of the work machines based on the digital twin models.

Referring still to FIG. 2, data passed from the work machine 102 to the ROM system 212 includes system data 204 and operating conditions data 208. According to examples, system data 204 may include data representing each component or selected components of the work machine 102 including physical dimensions, locations in the work machine, operating data (power requirements, power systems, electrical systems, hydraulic systems, pneumatic systems, etc.) relationships of one component to another component, and the like. In addition, all system data contained in work machine user manuals, parts manuals, repair and maintenance documentation including repair and maintenance historical data, and the like may be passed to the ROM system 212. That is, all system data 204 necessary for enabling the ROM system 212 to generate a reduced order model for the work machine 102 and associated components with which a digital twin 224 may be generated is passed to the ROM system 212.

As should be appreciated, system data 204 for the work machine 102 may be identical for all work machines 102 of a same model at the time of manufacture. However, as soon as a given work machine 102 is placed into service, use of the work machine 102 in varying ways (e.g., varying speeds, varying terrains, varying workloads, varying operating durations, etc.) in varying operating conditions may cause ROM modeling for one work machine 102 to differ from ROM modeling for another work machine 102. Thus, in order to individualize ROM modeling for each work machine 102, operating conditions data 208 for each individual work machine 102 is passed to the ROM system 212 so that a resulting ROM model for a given work machine 102 is generated based not only on the system data 204 for the work machine 102, but also on the operating conditions in which the work machine 102 operates.

According to examples, the work machine 102 may include an electronic control module (ECM) 202 that may pass operating conditions data for a work machine 102 to the ROM system 212. According to examples, the ECM 202 may include an onboard computer that controls electrical systems of the work machine 102 and that monitors, analyzes and diagnoses problems associated with the work machine 102 performance. The ECM 202 may monitor any component of the work machine for which sensors are deployed. For example, the ECM 202 may monitor component performance and status including, but not limited to work machine speed, acceleration, deceleration, loading/unloading/pushing forces, fuel consumption, ignition timing, battery charge levels, tire pressure, hydraulic and pneumatic systems fluid levels and pressures, breaking force data, and the like. The ECM 202 may also monitor physical features such as thickness of brake pads, ages of components, repair and maintenance histories, etc. In addition to monitoring such operating conditions data 208, the ECM 202 may perform diagnostics that may be provided to the ROM system 212, to the machine learning model 216 (described below) and/or to maintenance personnel.

According to examples, engineering personnel, maintenance personnel, fleet management personnel and the like may determine a set of specific components of the work machine 102 for which data will be sent to and processed by the ROM system 212. For example, components such as certain engine components, transmission systems, electrical systems, braking systems, hydraulic systems, pneumatic systems, and the like may be designated for sending data to the ROM system 212. For a given work machine 102, it may be determined that only those components for which component information is readily available owing to specific measurable component lifespans or the availability of sensor data may be processed by the ROM system 212 for generation of a digital twin and associated coaching and/or monitoring during use. That is, according to examples, system data passed or transmitted to the ROM system 212 or cloud-based analysis system, described herein, may include system data for one or more components of the work machine 102 for which component health data (e.g., based on specified component lifespan or sensor data) is available. Other components or features of the work machine 102 may be inspected manually, or data from other components or features may be reported to personnel separately from generation of a digital twin and associated coaching and/or monitoring, for example, via an edge device or other reporting functionality.

Referring still to FIG. 2, the reduced order model (ROM) system 212 may include sufficient computer-executable instructions for generating a ROM model for the work machine 102. As known by those skilled in the art, reduced order modeling includes, among other things, lowering the computational complexity of large data sets and dynamic systems and is particularly useful in generating simulations of such large data sets and dynamic systems. By lowering the computational complexity of modeling such large data sets and dynamic systems, a reduced order model (ROM) may be generated that approximates a model that considers all data of the large data set and dynamic systems. According to examples of the present disclosure, the system data 204 and the operating conditions data 208 described above represents such a large data set and dynamic system for which a non-reduced order model may be computationally difficult and time-consuming requiring significant computing resources.

According to examples, the ROM model generated for the system data 204 and operating conditions data 208 is, according to reduced order modeling, simplified which means some data points of the overall data set of the system data 204 and operating conditions data 208 will not be included in a resulting ROM model. However, use of a simplified model generated by the ROM system 212 allows for updating the ROM model efficiently and on-the-fly as changes in the system data 204 and operating conditions data 208 are received from the work machine 102. That is, by reducing the computational complexity of the ROM model using reduced order modeling, the ROM model may be continuously updated so that the coaching system 228 and monitoring system 232 may be updated as the system data 204 and operating conditions dated 208 changes.

In order to ensure the ROM model for the work machine 102 accurately represents the work machine 102 and its associated components, the ROM model may be validated against a non-reduced order model generated for the work machine. That is, a model may be generated for the work machine 102 based on system data 204 without using reduced order modeling, and the resulting model may be compared with a ROM model generated for the work machine 102. If variance between the two models is only attributed to those aspects of the work machine 102 system data 204 that are reduced as desired where the reduced data items are not needed for the desired digital twin 224 then the ROM model for the work machine 102 may be considered validated for use in the system 200 including in the coaching system 228 and/or monitoring system 232.

Referring still to FIG. 2, once the ROM model for the work machine 102 is generated by the ROM system 212 is validated for use, the ROM model may be updated as system data 204 changes and as operating conditions data 208 change. For example, as components of the work machine 102 change, for example, as sensors, such as a brake pad sensor, indicate that a component is wearing, updated sensor information for the component may be passed to the ROM system 212 as system data 204. Similarly, as operating conditions change, for example, as a work machine 102 is accelerated, braked, placed under loading, and the like, changes in such operating conditions may be passed to the ROM system 212 as operating conditions data 208.

As the ROM system 212 receives such updated data, the ROM model generated for the work machine 102 may be updated, and the digital twin 224 and coaching system 228 and monitoring system 232 for components of the work machine affected by the updated ROM model may be updated. Referring still to FIG. 2, according to examples, in addition to passing operating conditions data 208 the ROM system 212, changes in operating conditions data 208 may be passed to a machine learning model 216. As understood by those skilled in the art, machine learning systems are trained with large amounts of data including relationships (e.g., statistical relationships) between and among data items to identify patterns of data items. With each addition of data to machine learning systems, the machine learning systems improve their ability to identify relationships and patterns between and among data items. According to examples of the present disclosure, operating conditions data 208 may be fed into the machine learning model 216, and the machine learning model 216 may learn patterns and relationships between and among operating conditions data 208 associated with the work machine 102.

As illustrated in FIG. 2, information from the machine learning model 216 may be passed to the ROM system 212 for updating or enhancing the ROM model generated for the work machine 102. For example, if operating conditions data 208 indicate that for a given work machine 102 operation, extensive braking follows acceleration of the work machine after a load of material is picked up, the machine learning model 216 may learn that excessive brake pad wear occurs after periods of braking following acceleration. Such a learned pattern may be passed to the ROM system 212 for updating a subsequently generated ROM model for the work machine 102. The coaching system 228 and the monitoring system 232 may be used for coaching and monitoring operation of the work machine 102 and to guide use of the work machine 102 in a manner to reduce or eliminate undue stress and wear on the machine that may lead to machine downtime.

Referring still to FIG. 2, as the ROM system 212 generates updated ROM models for the work machine 102 based on received system data 204, operating conditions data 208 and information from the machine learning model 216, each updated ROM model for the work machine 102 is passed to the digital twin model system 220 for generation of a digital twin 224 of the work machine 102. According to examples, the digital twin model system 220 includes sufficient computer-executable instructions for generating a digital twin 224 for the work machine 102 including digital twins for each of the components of the work machine 102 for which system data 204 and operating conditions data 208 are passed to the ROM system 212. As known by those skilled in the art, a digital twin is a virtual representation of a physical object or system that is generated by simulating the features of the physical object or system based on data describing the physical object or system.

According to examples of the present disclosure, the digital twin model system 220 may generate a digital twin 224 of the work machine 102 based on data describing the components of the work machine 102 received from a ROM model generated by the ROM system 212 representing the work machine 102 and its various components. Because simulation generated by the digital twin model system 220 is computationally difficult and expensive, use of a ROM model describing the work machine 102 enables the digital twin model system 220 to generate the digital twin 224 of the work machine 102 based on system data 204, operating conditions data 208 and machine learning model 216 information received by the ROM system 212. In addition, information from the machine learning model 216 may be passed directly to the digital twin model system 220 to assist the digital twin model system 220 in decision-making during the process of simulating the components of the work machine 102. In addition to simulating the components of the work machine 102 for generation of the digital twin 224, the digital twin model system 220 may analyze the data received via the ROM model and machine learning model to develop component insights including prediction of component performance, wear and tear, and failure.

The coaching system 228 provides for operator coaching with structural digital twin models on-edge. The coaching system 228 integrates a physical-based digital twin and ROM technology to create a solution for component and system condition monitoring. ROM reduces model size and runtime while maintaining accurate predictions, making it useful for digital twins-based monitoring. The system uses virtual sensors and cameras, providing more insights than limited physical sensors which are also expensive and require maintenance. An ECM 202 of the work machine 102 may be used to calculate component stress levels and identify operator behavior that may result in excessive wear or damage to the work machine 102 under various operating conditions. Real-time feedback for operator instruction is provided from the computing system (e.g., the ECM or other associated system), allowing operators to adjust their actions before mechanical failure occurs.

The digital twin model system 220 and the coaching system 228 may be used to improve monitoring by the monitoring system 232 and reduce downtime for work machines, as described herein, for example by coaching operators to avoid actions or behavior that causes undue stress or wear on the equipment of the work machine 102.

The coaching system 228 integrates a physical-based digital twin and ROM technology to reduce model size and runtime while maintaining accurate predictions. The coaching system 228 and the monitoring system 232 enable digital twins-based component and system condition monitoring, reducing the need for numerous physical sensors. The systems use scalable virtual sensors and cameras, providing more insights than limited physical sensors. The virtual sensor output calculates component stress levels and identifies incorrect operator behavior under various operating conditions. Real-time feedback for operator instruction is then sent to on-site operation including on-board the work machine 102 and/or to an on-site operator, allowing operators to adjust their actions before mechanical failure occurs.

ROM can reduce the model size and runtime significantly, while maintaining accurate predictions. Because of these benefits, ROM is useful and an enabler of digital twins-based component and system condition monitoring. These digital twins can leverage the “virtual sensor” techniques, decreasing the need for numerous physical sensors which are costly, difficult to install, and prone to environmental damage. Additionally, the reduced model size and reduce computing demands enable calculations at or near real-time using the limited computing systems that may be positioned on-board the work machine 102 for example in an ECM.

The monitoring system 232 may be used for monitoring use of the work machine 102 including stress and strain on the equipment during operation as well as to provide coaching to guidance to an operator on techniques for using the equipment without undue wear and tear on the equipment that may increase machine downtime and maintenance. According to examples of the present disclosure, a health indicator may be applied to a feature of the system and may be used for monitoring and real-time coaching for the work machine 102.

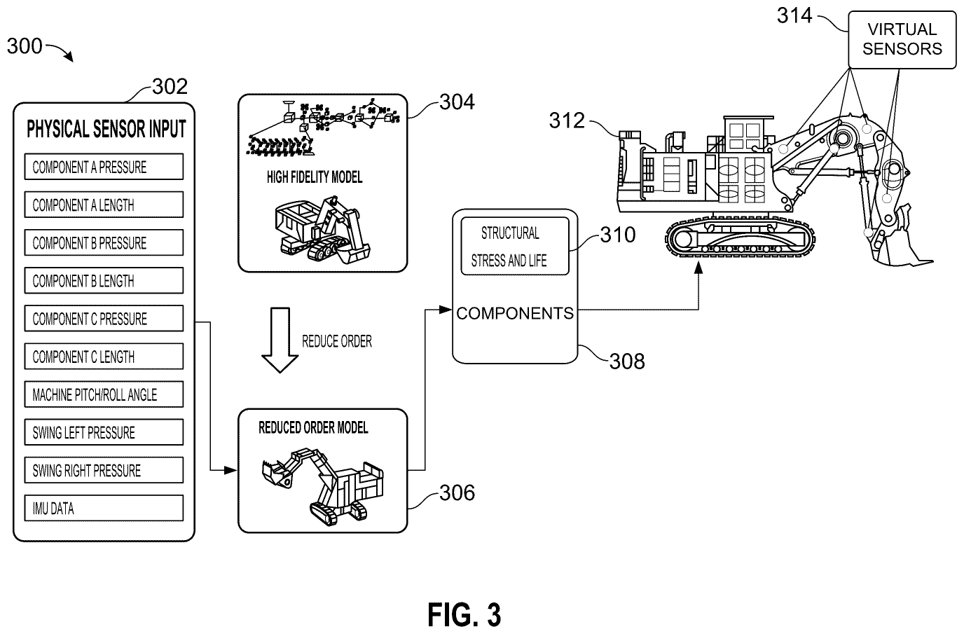

FIG. 3 illustrates an architecture 300 for utilization of a ROM-based digital twin, according to examples of the present disclosure. The architecture 300 may be implemented on a work machine such as an HMS or other such equipment. The architecture 300 is provided to generate the ROM and digital twin of the work machine that may be used on-board the work machine for real-time coaching as well as for monitoring the use and lifespan of the work machine.

The architecture 300 uses data from one or more physical sensors 302 that may be equipped on the work machine. In examples the physical sensors may include boom cylinder pressure sensors, boom cylinder length sensors, stick cylinder pressure sensors, stick cylinder length sensors, bucket cylinder pressure sensors, bucket cylinder length sensors, machine pitch sensors, roll angle sensors, swing pressure sensors (e.g., for swinging in a right and a left direction), as well as sensor data from an inertial measurement unit (IMU), among other sensors. The physical sensors 302 may include sensors that are already equipped on a work machine and may be used as-is without requiring retrofitting or addition of additional sensors. The architecture 300 instead uses the available physical sensors of the work machine with a reduced order model 306 to simulate the structural stress 310 and the expected lifespan of the components 308 of the work machine.

The architecture 300 provides for generation of the ROM 306 from a high-fidelity model 304 of the work machine that may be developed as part of production of the work machine. Such a high-fidelity model 304 may require extensive computational resources to provide simulations of the work machine and therefore may not be able to run at an on-board computing device of the work machine such as an ECM and may also run too slowly to provide valuable or meaningful input to an operator until well after an operation is completed. Accordingly, the architecture provides for generating the ROM based on the high-fidelity model of the work machine. The ROM may be generated using one or more techniques including at least a machine learning technique to output the ROM in response to receiving the high-fidelity model.

The high-fidelity model 304 created for product development can be leveraged to improve condition monitoring applications and coaching in real time by reducing down to the ROM. A physics-based simulation model that has been calibrated to closely match the normal behavior of the physical system is defined as a digital twin of that physical system. A calibrated digital twin for normal behavior can be converted to a lower fidelity model e.g., ROM based on deep learning to improve efficiency and lower cost of the baseline comparisons. The physical sensors 302 and the data therefrom can be used as inputs for the digital twin 312. The digital twin 312 may be refined based on evaluation of differences in outputs between the ROM and the physical sensors 302. For example, if the outputs of the system are within a defined threshold (within e.g., 10 percent of the ROM), the ROM 306 and digital twin 312 may be used. Accordingly, the simulated or modeled components 308 of the work machine and the simulation of the structural stress 310 can be used and compared against physical sensor 302 outputs. The use of virtual sensors 314 positioned on the digital twin 312 enable the architecture to provide real-time monitoring of stresses and/or wear on components 308. The virtual sensors 314 may be of any number, and are not limited by cost and/or physical constraints on the work machine, and virtual sensor 314 outputs may be compared against the physical sensor 302 outputs to further refine the digital twin 312 and/or the ROM 306.

Based on the virtual sensors 314 and the digital twin 312, the architecture 300 may be used in conjunction with the coaching system and/or monitoring system described above to provide coaching and guidance for use of the work machine in a manner that reduces operations that significantly impact the life of the work machine and/or components thereof. The virtual sensors 314 and the digital twin 312 may provide outputs that are used as inputs to the coaching system and/or monitoring system. The outputs from the virtual sensors 314 may include calculations of stresses or forces at the locations of the virtual sensors. The outputs from the virtual sensors 314 may be used to display and/or provide real-time display to the operator and/or a central controller or remote computing device. The outputs may also be used to determine coaching guidance, for example to avoid certain behaviors or operations with the work machine. The coaching system and/or monitoring system may use one or more models, algorithms, machine-learning, heuristics, or other approaches to identify behavior and/or operations that impact the life of the work machine and/or components.

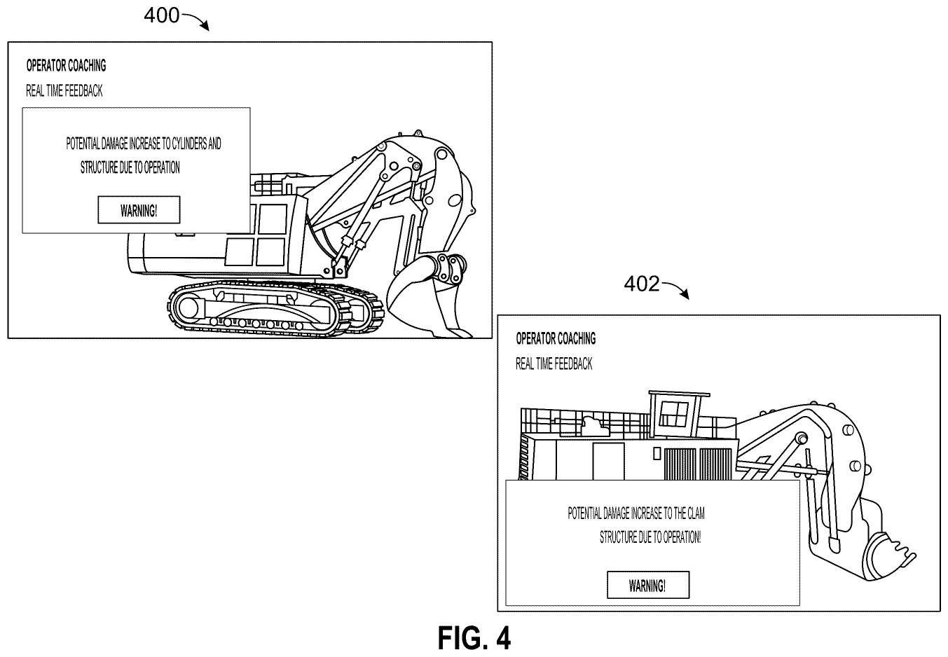

In an illustrative example, the virtual sensors 314 output from the digital twin 312 can be used on-board the ECM of the work machine to calculate stress levels of components 308 at or near real-time. The stress calculations are used to identify behavior or operations performed by the operator that are causing stresses or wear on the components of the work machine. Some non-limiting examples of operator behavior that may be identified based on the virtual sensor data includes jump steering (e.g., boom jacking), cylinder end stroke (reaching or exceeding the maximum cylinder extension length), wall scraping, swing impacts, sweeping, hammering, levering, tipping, or other such behavior that may be outside of normal expected behavior the work machine is designed for and therefore may reduce the working life of the work machine. Examples of interfaces to alert an operator in real-time of such behavior are shown and described with respect to FIG. 4, but are meant to be illustrative and non-limiting.

The detection of events such as the operator behaviors above may be performed using machine learning approaches, for example machine learning trained on use data for work machines including virtual sensor data labeled with particular operator behaviors. The operator behaviors may also be determined or detected by the ECM of the work machine based on heuristics developed based on experienced operators and/or machine designers based on identified stresses and/or machine feedback and simulation. Other techniques may be implemented to identify such behaviors and subsequently notify an operator of the behavior (e.g., to provide a warning that continued operation in such a manner reduces the working life of the work machine and/or one or more components thereof).

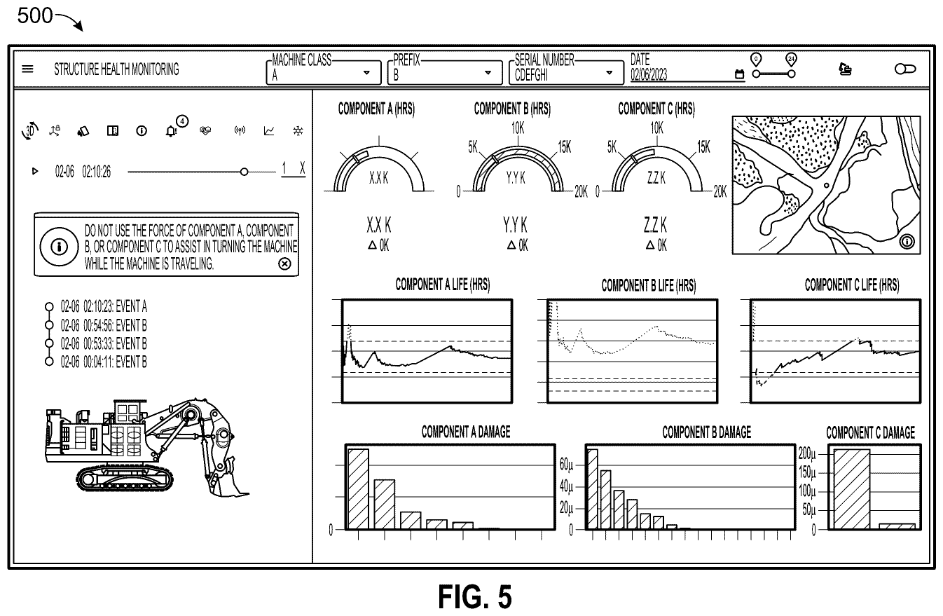

In some examples the coaching system and monitoring system may be used for management of a fleet of work machines, for example to schedule maintenance based on identifying machines that may experience reduced work life or damage based on instances of operator behavior such as described above that negatively impact the work machine. In an illustrative example, a monitoring system may track hours of use of the work machine and may also receive, from the ECM and/or coaching system, the virtual sensor data or the outputs of identified operator behavior. The monitoring system may then adjust expected lifespans for components based on the identified behaviors, the level of stress involved with the operations, and the number of instances of a particular behavior. Accordingly, a particular component such as a boom may have an expected lifespan when installed but due to behaviors such as boom jacking the life of the boom may be reduced. The monitoring system identifies the stresses in the boom, identifies instances of boom jacking, and reduces the expected lifespan for the boom accordingly. The monitoring system may therefore be used in concert with a maintenance system, for example to schedule maintenance for machines as components near an end of their expected usable lifespan but before failure occurs, which may cause significantly longer downtime to repair a failure rather than to replace a component. Examples of user interfaces with such monitoring information are shown and described with respect to FIGS. 5-7 herein.

FIG. 4 illustrates example user interfaces for implementing a ROM-based digital twin of an equipment system for operator coaching, according to examples of the present disclosure. A first user interface 400 and a second user interface 402 illustrate example user interfaces that may be displayed to an operator, for example at a display within a cab of a work machine. The first user interface 400 and the second user interface 402 may be generated in response to the coaching system determining, based on the virtual sensors 314 of the digital twin 312 that a particular operation that is associated with a reduced lifespan for a component has occurred. Though the first user interface 400 and the second user interface 402 are depicted providing warnings with respect to a cylinder end stroke and boom jacking, other warnings and/or information may be provided with the interfaces. The coaching system may produce the interfaces such as shown herein when operations such as jump steering (e.g., boom jacking), cylinder end stroke (reaching or exceeding the maximum cylinder extension length), wall scraping, swing impacts, sweeping, hammering, levering, tipping, or other such behavior that may be outside of normal expected behavior the work machine is designed for and therefore may reduce the working life of the work machine. In some examples the coaching system may also provide description of alternative approaches (e.g., a recommendation) for the operator or information related to a likelihood of damage to the work machine based on the operation. Such a recommendation and/or likelihood of damage may be generated by a machine learning model, algorithm, or other such technique based on historical information and/or heuristics.

FIGS. 5-7 depict example user interfaces that may be used to monitor lifespan for one or more work machines as part of a fleet of work machines. The user interfaces may be presented at a monitoring or central controller location such as a back office or site controller. Though the interfaces are shown with particular information and data the user interfaces may have other appearances and/or show other data or information that may be used for one or more purposes such as tracking lifespan of components, wear and tear on work machines, scheduling maintenance, ordering replacement components, and identifying common operator behavior to provide additional training (e.g., to further train on how to avoid such behaviors).

FIG. 5 illustrates an example user interface 500 for monitoring equipment using a ROM-based digital twin, according to examples of the present disclosure. The user interface 500 may be presented at a computing device such as a computing device within a cab of the work machine and/or at a remote computing device in communication with the computing device of the work machine, such as a site controller or back-office computing device.

The user interface 500 provides options for selecting a particular work machine from among a fleet of different types of machines. The user interface may then provide information such as a timeframe for any operations or events identified by the coaching system within a predetermined window (e.g., a shift, day, week, or other such time period as may be defined). The user interface 500 may also include a representation of the digital twin of the work machine and may use the representation of the digital twin to illustrate particular operations that may have occurred and/or to highlight stresses or components at risk as a result of particular operations. For instance, a user may select a particular operation identified by the coaching system and the representation may display the calculated stresses (e.g., using a colormap or other such display technique) and/or identify components that received excessive force or experienced stresses over a threshold level, as determined based on the virtual sensor data.

The user interface may also provide information related to particular components, such as the boom, stick, and/or clam. The information may relate to hours of service, expected life (e.g., predicted based on hours, usage, stresses, digital twin simulation, etc.), and predicted damage based on the virtual sensor data. The user interface 500 may allow for a user to select additional information and/or view at or near real-time based on a communication connection with the work machine, such as over satellite.

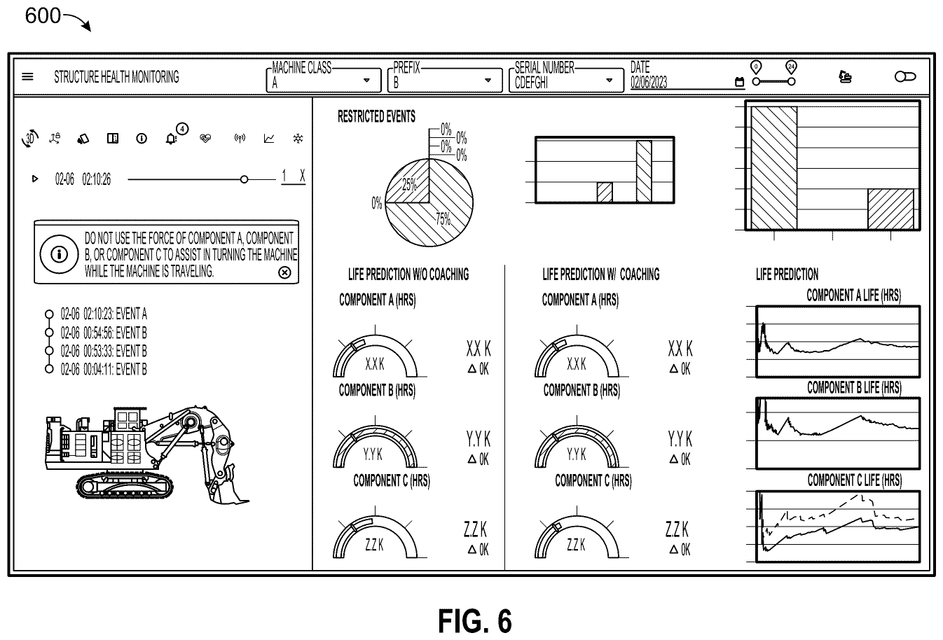

FIG. 6 illustrates an example user interface 600 for monitoring equipment using a ROM-based digital twin, according to examples of the present disclosure. The user interface 600 may be similar to the user interface 500 described above and may include similar or identical information. In addition, the user interface 600 may show a comparison and/or the impact of coaching, for a work machine with coaching enabled such that a user may be able to view and estimate the expected lifespan with coaching compared against the lifespan without coaching, which may be based on historical data related to lifespan and/or instances of restricted events. The user may be able to view an operator compliance with the coaching based on the user interface 600. In examples, the coaching and/or monitoring system may recommend training or other action be taken.

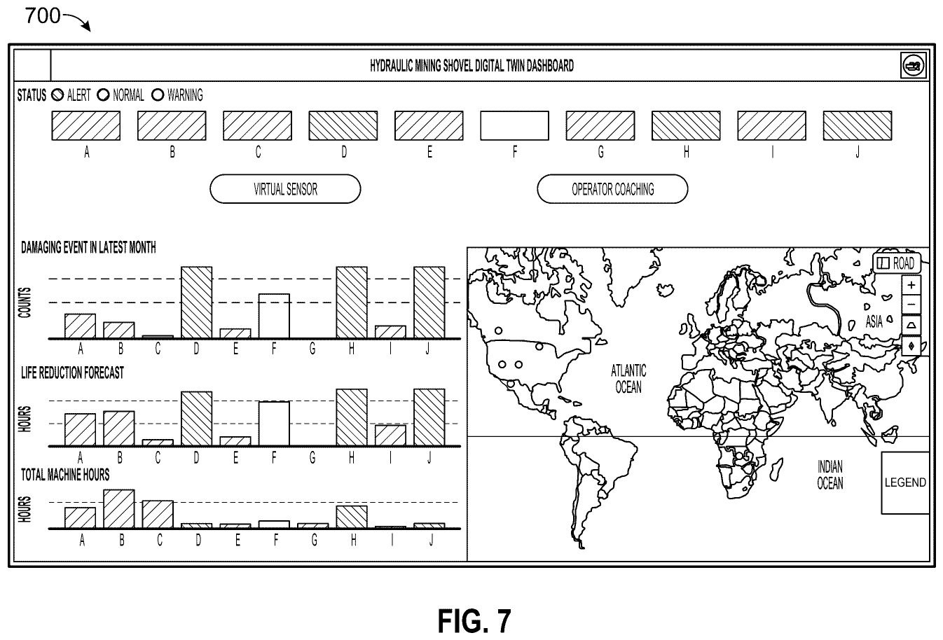

FIG. 7 illustrates an example user interface 700 for monitoring equipment using a ROM-based digital twin, according to examples of the present disclosure. The user interface 700 may provide a user with an ability to monitor across a fleet of machines to identify or view trends and other such information. For example, the user interface 700 is shown with a fleet of work machines that may be independently selectable to view detailed information related to each work machine, such as the information shown in FIGS. 5-6 herein. Across the fleet, which may be spread across a geographic area, the number or damaging events may be shown, predicted reduction in life of components or machines, and total machine hours may be viewed. Such information may be used to identify regions, use cases, or other factors that are impacting how the machines in the fleet are used.

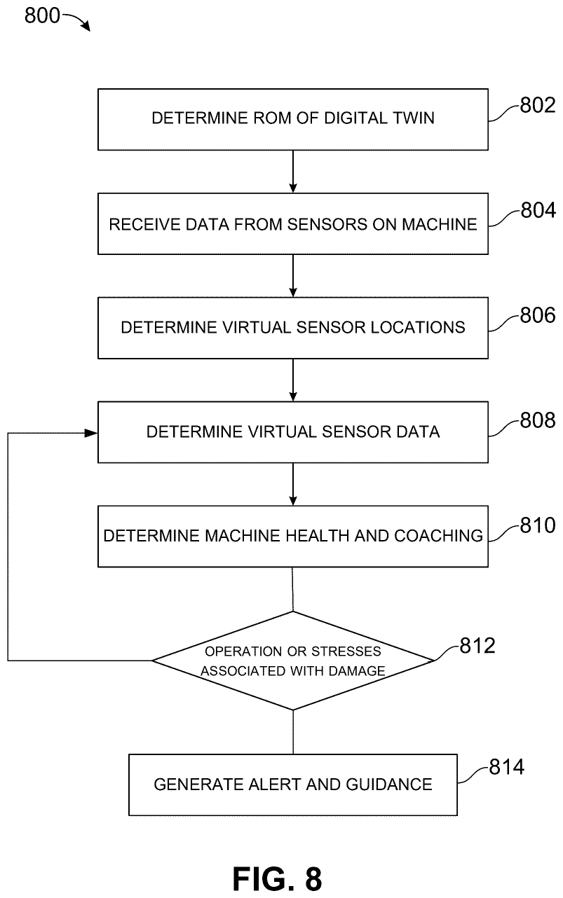

FIG. 8 illustrates a flow diagram of an example method for generation and utilization of a ROM-based digital twin of an equipment system, according to examples of the present disclosure. The process 800 may be performed, at least in part, by a processor of a computing device, such as the user device and/or a subsystem of the work machine as described herein. The process 800 may be performed on one or more devices within the user device. The process 800 may be implemented as processor-executable instructions that may be stored on a suitable non-transitory storage medium. Though depicted in a particular order in FIG. 8, the steps of process 800 may be performed in other orders or arrangements, and in some examples, process 800 may include additional or fewer steps than depicted in FIG. 8.

The process 800 begins at operation 802 with the on-board computing device, such an ECM receiving the ROM model of the machine. The ROM may be produce as described herein to represent the machine with a level of complexity that enable calculations to be performed on-board the machine with limited computing resources. The ROM is built for the work machine by an ROM system, for example using a machine learning model. The ROM model may be updated during the process 800 based on additional data such as data from the machine sensors or other inputs.

The process 800 includes receiving, at the ECM of the work machine and at operation 804, data from sensors of the machine. The sensors may include existing component sensors of the machine such as boom cylinder pressure sensors, boom cylinder length sensors, stick cylinder pressure sensors, stick cylinder length sensors, bucket cylinder pressure sensors, bucket cylinder length sensors, machine pitch sensors, roll angle sensors, swing pressure sensors (e.g., for swinging in a right and a left direction), as well as sensor data from an inertial measurement unit (IMU), among other sensors. The sensor data may be implemented with the ROM model to build a digital twin of the work machine with real time operating conditions data passed to the ROM and used with the digital twin to simulate the work machine.

At operation 806, the process 800 includes determining virtual sensor locations on the digital twin of the machine. The virtual sensor locations may be placed by a user designating locations, using default locations, and/or based on an automated approach to place sensors within the digital twin. The automated approach may include using the digital twin to identify areas of stress (e.g., above a threshold level of stress) and placing virtual sensors at or in proximity to such locations.

At operation 808 the digital twin is used to determine virtual sensor data for each of the virtual sensors. The virtual sensor data may include sensor data such as stress, pressure, load, forces, or other suitable types of data that may be used to identify and determine how the work machine is being loaded and used during operations.

At operation 810 the process 800 includes using the virtual sensor data and the coaching system to identify instances when a behavior or operation corresponds to a behavior or operation previously identified as associated with a shortened lifespan for a component. The machine health and coaching may also include identifying, at operation 812 if an operation performed by the machine and/or stresses within the machine are associated with damage to the machine based on the virtual sensor data. The operation or stresses may be determined to exceed one or more predetermined thresholds, beyond which the lifespan is expected to be prematurely shortened due to excessive wear. In such situations the process 800 may include generating an alert and/or guidance to the operator and/or a second computing device or other system associated with the operation or the stress. The coaching system may generate and output a notification of such conditions to an operator and may, in some instances, provide a recommendation for an alternative operation. Additionally, the virtual sensor data and/or coaching system data may be conveyed to a monitoring system that may be used to monitor one or more work machines from a central controller location, for example to schedule maintenance, repairs, replacements, or perform other such actions with the machine to prevent downtime from failed components. In the event that the operation and/or stress is not determined to be in excess of the thresholds, then the process 800 may include returning to determining virtual sensor data in real-time as operations are performed at operation 802.

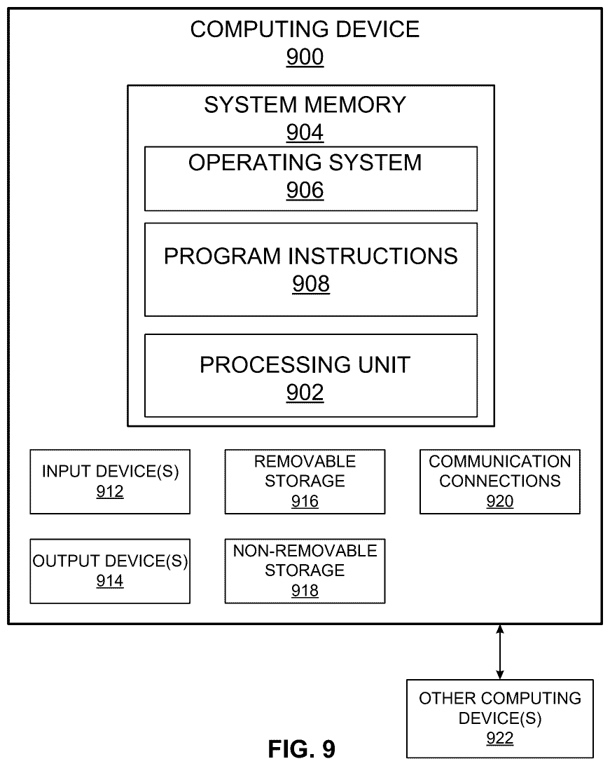

FIG. 9 is a block diagram illustrating physical components of an example computing device with which examples of the present disclosure may be practiced. The computing system 900 may include at least one processing unit 902 and the system memory 904. The system memory 904 may comprise, but is not limited to, volatile (e.g., random access memory (RAM)), non-volatile (e.g., read only memory (ROM)), flash memory, or any combination thereof. System memory 904 may include an operating system 906, one or more program instructions 908, and may include sufficient computer-executable instructions for operating the ROM-based digital twin and AR/MR/VR system 200, described herein. Operating system 906, for example, may be suitable for controlling the operation of the computing system 900. Furthermore, examples may be practiced in conjunction with a graphics library, other operating systems, or other application programs and is not limited to any application or system. This basic configuration is illustrated by those components within a dashed line 910. The computing system 900 may also include one or more input device(s) 912 (e.g., keyboard, mouse, pen, touch input device, etc.) and one or more output device(s) 914 (e.g., display, speakers, printers, etc.).

The computing system 900 may also include additional data storage devices (removable or non-removable) such as, for example, magnetic discs, optical discs, or tape. Such additional storage is illustrated by removable storage 916 and a nonremovable storage 918. The computing system 900 may also contain a communication connection 920 that may allow the computing system 900 to communicate with other computing devices 922 such as over a network in a distributed computing environment, for example, an intranet or the Internet. The communication connection 920 is an example of a communication medium, via which computer-readable transmission media (i.e., signals) may be propagated.

Program modules may include routines, programs, components, data structures, and other structures that may perform tasks or that may implement abstract data types. Moreover, examples may be practiced with other computer system configurations, including hand-held devices, multiprocessor systems, microprocessor-based or programmable user electronics, minicomputers, mainframe computers, and the like. Examples may also be practiced in distributed computing environments where tasks are performed by remote computing and processing devices that are linked through a communications network. In a distributed computing environment, programming modules may be in both local and remote memory storage devices. Furthermore, examples may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SOC)). Examples may also be practiced using other technologies capable of performing logical operations such as, for example, AND, OR, and NOT, including but not limited to mechanical, optical, fluidic, and quantum technologies. In addition, examples may be practiced within a general-purpose computer or in other circuits or systems.

Examples may be implemented as a computer process (method), a computing system, or as an article of manufacture, such as a computer program product or computer-readable storage medium. The computer program product may be a computer storage medium readable by a computer system and encoding a computer program with instructions for executing a computer process. Accordingly, hardware or software (including firmware, resident software, micro-code, etc.) may provide examples discussed herein. Examples may take the form of a computer program product on a computer-usable or computer-readable storage medium having computer-usable or computer-readable program code embodied in the medium for use by, or in connection with, an instruction execution system.

Examples of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented within the computing system 900 or any other computing devices 922, in combination with the computing system 900, where functionality may be brought together over a network in a distributed computing environment, for example, an intranet or the Internet to perform the functions described herein. Systems, devices, and processors described herein are provided as examples; however, other systems, devices, and processors may comprise the memory storage and processing unit, consistent with the described disclosure.

### Industrial Applicability

Systems and methods provide for leveraging digital twin generation, artificial intelligence and machine learning analytics, and on-board computing resources of work machines. As such, an operating environment for machines may be maintained such that operators keep machines within prescribed working conditions and operations to avoid premature failure of components and reduced lifespan of component. According to examples, equipment operators, operator training personnel, maintenance personnel, and fleet management personnel may visualize equipment systems, visualize impacts of particular operations as performed using the work machine, and provide up-to-date and real-time information to operators to avoid costly downtime and repairs as a result of damage to work machines from improper uses.

Generation of a reduced order model (ROM)-based digital twin and on edge simulation of the work machine enables real-time detection of operations or behaviors using the work machines that would negatively impact the lifespan of the work machine and/or one or more components in particular. By generation of and use of a ROM-based digital twin, the digital twin may be simulated on-board the work machine and the calculations may be performed at or near real-time such that the operator gets helpful feedback in an actionable timeframe, e.g., while they are still performing the operation. Because ROM modeling reduces the computational complexity of a model from which the digital twin is generated it enables such calculations to be on edge and performed in real-time.

A reduced order model (ROM) may be generated for each desired component of a work machine. The ROM model may be initially generated based on specifications of the work machine including detailed information on each component of the work machine. The initially generated ROM model may be enhanced by feeding the ROM model real-time component data such as received from internal sensors associated with work machine components and by feeding the ROM model with real-time operating conditions such as work machine speed, acceleration, deceleration, braking, work machine loading data, work machine operating terrain, work machine material handling information, as well as environmental conditions such as temperature, wind velocity, moisture presence, and the like. Information used for enhancing or tuning an initially generated ROM model may be fed directly to the ROM model or may be processed by a machine learning and artificial intelligence system that, in turn, may feed information to enhance the ROM model to a ROM model system.

After generation of an initial ROM model and/or after enhancement or tuning of the initial ROM model with real-time information, a digital twin of the work machine and its components may be generated. Virtual sensors may be placed within the digital twin, without incurring costs of hardware and also enabling positioning of sensors in locations that may not be accessible or possible to place physical sensors. A coaching model may then aid operators of the work machine, operator training personnel, maintenance personnel, and/or fleet management personnel to ensure operations that may damage the work machine components are avoided or minimized, reducing downtime for the work machine, determining problems with components of the work machine, predicting future problems with components of the work machine, training operators of the work machine, assisting maintenance personnel, and assisting in management of work machine fleets.

Accordingly, the systems and methods described herein provide monitoring to enable early failure detections or even preventions. The description provided herein enables early detection of component wear and/or early prediction of wear or failure of components at individual machines and/or across fleets of machines. Additionally, the description provides for coaching operators of equipment to prevent excessive wear or damage to equipment components during operation. Accordingly, the description provided herein enables real-time operation coaching model that includes structural health monitoring.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A method, comprising:
receiving system data from a work machine, the system data associated with one or more components of the work machine;
providing the system data to a reduced order model system;
at the reduced order model system, generating a reduced order model for the one or more components of the work machine;
providing the reduced order model for the work machine to a digital twin model system;
at the digital twin model system, generating a digital twin for the one or more components of the work machine; and
generating an alert at a human machine interface of the work machine in response to the digital twin model system, the alert related to a potential future event associated with wear on the work machine.

2. The method of claim 1, further comprising:
determining one or more virtual sensor locations for the digital twin;
determining virtual sensor data based on the digital twin and the one or more virtual sensor locations; and
determining work machine monitoring data based on the virtual sensor data, wherein the alert is generated based on the work machine monitoring data.

3. The method of claim 2, further comprising:
conveying the work machine monitoring data to a remote computing device; and
determining one or more fleet-wide monitoring characteristics identifying an operation or wear characteristic of a fleet of work machines based on the work machine monitoring data.

4. The method of claim 1, further comprising:
receiving updated system data from the work machine;
providing the updated system data to the reduced order model system;
at the reduced order model system, updating the reduced order model for any of the one or more components for which updated system data is received;
providing the updated reduced order model for the work machine to the digital twin model system; and
at the digital twin model system, generating an updated digital twin for the any one or more components for which updated system data is received.

5. The method of claim 4, prior to generating an updated digital twin for the any one or more components for which updated system data is received, further comprising:
receiving real time operating conditions data for the work machine; and
providing the real time operating conditions data for the work machine to the reduced order model system.

6. A method of claim 5, further comprising:
receiving updated real time operating conditions data for the work machine,
providing the updated real time operating conditions data for the work machine to the reduced order model system; and
at the reduced order model system, updating the reduced order model for the one or more components of the work machine.

7. The method of claim 5, further comprising:
providing the real time operating conditions data for the work machine to a machine learning model;
training the machine learning model with the real time operating conditions data;
providing information associated with the real time operating conditions data from the machine learning model to the reduced order model system; and
updating the reduced order model for the one or more components of the work machine.

8. A system, comprising:
a work machine; and
an electronic control module configured to:
determine a reduced order model for the work machine based at least in part on system data received at the electronic control module and real-time operating conditions data for the work machine;
determine virtual sensor data describing characteristics of one or more components of the work machine during operation of the work machine; and
determine work machine monitoring data based on the virtual sensor data and the reduced order model.

9. The system of claim 8, further comprising generating a digital twin of the work machine based on the reduced order model, wherein determining the virtual sensor data is associated with the digital twin.

10. The system of claim 9, wherein the digital twin is generated from the reduced order model using a machine learning system.

11. The system of claim 8, further comprising determining one or more real time insights based on the work machine monitoring data, the one or more real time insights associated with coaching directions output to an operator related with reducing wear and stress on the work machine.

12. The system of claim 11, further comprising transmitting the work machine monitoring data and the real time insights to a coaching system for training work machine operations based at least in part on the real time insights.

13. The system of claim 8, further comprising conveying the work machine monitoring data to a remote computing device; and
determining one or more fleet-wide monitoring characteristics identifying an operation or wear characteristic of a fleet of work machines based on the work machine monitoring data.

14. The system of claim 8, further comprising transmitting operating conditions data from the work machine to an edge device configured to generate real time insights associated with the operating conditions data.

15. A method, comprising:
receiving data from one or more sensors of a work machine;
determining a reduced order model for the work machine based at least in part on system data received at an electronic control module of the work machine and real-time operating conditions data for the work machine;
determining virtual sensor data describing characteristics of one or more components of the work machine during operation of the work machine; and
determining work machine monitoring data based on the virtual sensor data and the reduced order model.

16. The method of claim 15, further comprising generating a digital twin of the work machine based on the reduced order model, wherein determining the virtual sensor data is associated with the digital twin.

17. The method of claim 16, wherein the digital twin is generated from the reduced order model using a machine learning system.

18. The method of claim 15, further comprising transmitting operating conditions data from the work machine to an edge device configured to generate real time insights associated with the operating conditions data.

19. The method of claim 15, further comprising determining one or more real time insights based on the work machine monitoring data, the one or more real time insights associated with coaching directions output to an operator related with reducing wear and stress on the work machine.

20. The method of claim 19, further comprising transmitting the work machine monitoring data and the real time insights to an immersive training system for training work machine operations based at least in part on the real time insights.
